(19) United States
(12) Patent Application Publication
(10) Pub. No.: US 2021/0350475 A1
(43) Pub. Date: Nov. 11, 2021

(54) SYSTEM AND METHOD FOR TEAM PARTICIPANT SPONSORSHIP

(71) Applicant: Student Player, LLC, Houston, TX (US)

(72) Inventors: Andrew P. Segal, Houston, TX (US); Henry Segal, Houston, TX (US); Justin Segal, Houston, TX (US); Zachary Segal, Houston, TX (US)

(73) Assignee: Student Player, LLC, Houston, TX (US)

(21) Appl. No.: 17/316,950

(22) Filed: May 11, 2021

Related U.S. Application Data
(60) Provisional application No. 63/022,910, filed on May 11, 2020.

(51) Int. Cl. G06Q 40/00

(52) U.S. Cl. CPC G06Q 40/125

(57) ABSTRACT

A computer-implemented method including retrieving information of aggregate amounts sponsored for a particular sports team from a plurality of sports teams, determining the amount allocated to a sports team participant by the participant's position for a particular team, detecting that a particular team participant has completed one or more specified commitments, determining, based upon whether the team participant has completed said specified commitments, the portion of the aggregate amount sponsored for a particular sports team that is paid to the particular team participant based on the participant's position; and causing a monetary disbursement to the particular team participant.

### CROSS-REFERENCE TO RELATED APPLICATIONS

This application claims priority to U.S. Provisional Patent Application Ser. No. 63/022,910, filed May 11, 2020.

### BACKGROUND OF DISCLOSURE

### Field of the Invention

The present invention generally relates to computer implemented sponsorship methods and systems for sponsoring athletic team participants and sports programs, including, without limitation, more specifically, systems and methods for sponsoring amateur athletic participants and collegiate sports programs in return for their endorsements. Further, this disclosure relates to methods and systems that enable sports fans to collectively fund various collegiate programs and players by position.

### Background

There are over 500,000 student athletes in the United States. Historically, student athletes were forbidden by the National Collegiate Athletic Association (NCAA) from receiving compensation for the use of their name, image, and/or likeness (“NIL”). On Sep. 30, 2019, Gavin Newsom, the Governor of California, signed the Fair Pay To Play Act into law which in pertinent part prohibits post-secondary institutions in California from preventing a student athlete from receiving compensation from the use of the student's NIL. The Fair Pay To Play Act becomes operative on Jan. 1, 2023. Other state and federal elected officials are currently working on similar NIL legislation (“NIL Laws”) that will likely expand California's standard to the rest of the country. Subsequent to California's decision, the NCAA board voted to initiate a process that will let student athletes “benefit from the use of their, name, image, and/or likeness.” The NCAA's respective divisions were mandated to “immediately begin considering modification and modernization” of the rules and bylaws. The necessary changes are required to be made no later than January 2021.

These changes will have a substantial impact for the over 500,000 student athletes and the schools they attend and usher in new opportunities to assist student athletes and other athletic participant to take advantage of NIL Laws. The tangible consequences for existing athletes may only be felt in 2021, or later, but the market for prospective athletes is already being impacted. Recruiting top athletes and other athletic participants has traditionally been extremely competitive, but largely opaque. With student athletes unable to benefit from their NIL rights, and schools unable to pay them, coaches have traditionally relied on: 1) the quality of a school's athletic facilities and 2) the ability to make the player more marketable when he/she is eligible to enter a professional league. With the changing legal landscape permitting compensation for NIL rights, there exists a need for a system and method to shift the balance of power to the athletic participants, sponsors and fans by allowing athletic participants to be compensated in accordance with NIL related laws and rules in a transparent manner. One innovative aspect of the present disclosure is to present a method to democratize the recruitment process by giving contributors, team participants and sponsors a voice in the formation and development of sports teams.

A sponsorship method and system according to this disclosure is designed to enable individual sports fans, entities, and/or groups to make contributions to accounts set up for sports programs that are to be held in escrow for athletic participants, such as student athletes (e.g., college athletes), and such as embodied by the program enabled by Student Player™ (www.studentplayer.com), as incentives for such athletes to attend such institutions. The innovative method of the disclosure will offer team participants compensation for the use of their NIL rights in endorsements.

The sponsorship funds are held in escrow and released to the team participant once the he/she fulfills one or more of his/her sponsorship obligations or milestones. In some embodiments, the team participant may be required to meet one or more milestones before he or she can receive money from such escrowed funds.

One purpose of the current invention is to offer endorsements to a team participant based on his/her school, team, and position, and to provide a more complete picture to the athletic participant and others of what compensation he/she can expect to earn by participating in an athletic program at a given school.

Another purpose of the current invention is to provide an alternative method for compensating a team participant for his/her NIL rights without tying compensation to the participant's performance or as an inducement to select, remain at, or transfer to a specific institution. Instead, the system provides sponsorship opportunities to team participants based on the position or role they play at the school they attend (e.g. the starting quarterback at University of Southern California will be offered a sponsorship deal of $X, while the place kicker at Stanford will be offered a sponsorship deal of $Y.)

Another innovative aspect of the invention is to remove the necessity of a middleman, agent or representative for a team participant to capitalize on his/her NIL rights. As such, the team participant can enjoy greater benefits without necessarily having to share a portion with others.

Another innovative aspect of the invention is to make compensation for NIL rights available to less desirable team participants, by permitting sponsorship opportunities for entire teams or programs at various levels. Certain sponsors may have a willingness to engage in certain sponsorships at certain times, with respect to certain products or to sponsor certain individuals or entire teams, or in certain geographic locales.

Another innovative aspect of the invention is to allow crowdfunding for the sponsorship of team participants and to allow prospective team participants to review and compare their potential earning capacity between different institutions. The strength of a team participant's desire to join a team may come from numbers of sponsors and/or contributors to that particular team. As many collegiate sports have a high risk of injury, and few team participants go beyond to professional sports, top team participants will want to understand their earning potential while participating in collegiate athletics. Contributors to sponsorships, perhaps fans and alumni of a particular institution, can send a signal that playing for their alma matter can result in substantial compensation. The ability to offer sponsorship deals may only take place in 2021, or later, but will already impact today's recruits who will be the starters of the future.

The term athletic participant as used herein is used in its broadest sense, and in various embodiments may include players, coaching staff, trainers, and support and administrative staff for a sports team or other team. The novel sponsorship system disclosed herein, although primarily discussed in terms for NCAA athletes with NIL rights in exemplary embodiments, may apply to a sponsorship system for different athletes and other team participants, including, without limitation, other amateur team participants, professional team participants, club team participants, other teams at schools and teams outside the school setting.

Thus, the need exists for a system and method as the present disclosure for a sponsorship program to take advantage of compensation to team participants or their NIL rights as described above, and in more detail below.

### SUMMARY

The present invention implements a computerized sponsorship system, method and apparatus. In general, the invention described in this specification can be embodied in methods that include the actions of retrieving by a computer information aggregate amounts sponsored for a particular sports team from a plurality of sports teams; determining the amount allocated to a team participant by the participant's position for a particular sports team; detecting whether a particular team participant has completed one or more specified commitments; determining, based upon whether the team participant has completed said specified commitments, the portion of escrowed funds that is paid to the particular team participant based on the participant's position; and causing a monetary disbursement from escrowed funds to the particular team participant.

A system of one or more computers can be configured to perform particular operations or actions by virtue of having hardware, firmware, software, a hardware storage device or a combination of them installed on the system that in operation causes or cause the system to perform the actions. The exemplary sponsorship system may include one or more servers, each including one or more processors, for administering a sponsorship method. The system may be configured to communicate with (e.g., to be networked over the internet with, etc.) a number of other devices, including third party servers and user devices (e.g. laptops, tablets or smart phones), from which the sponsorship system may receive data, instructions or other information and/or to which the sponsorship system may deliver data, instructions or other information, and make a monetary disbursement to the team participant (e.g. from PayPal or Venmo). In some embodiments, the other devices that communicate with the server or servers of a sponsorship system may be considered to be part of the sponsorship system. The system includes an interface to the system for the users, the interface being provided by the processor and permitting the users to view and modify the configurational hierarchies. Each user has access to one or more of the hierarchies, and each user can have different access permissions in different hierarchies.

Other embodiments of this aspect include corresponding computer systems, apparatus, and computer programs recorded on one or more computer storage devices, each configured to perform the actions of the methods described herein.

The sponsorship program may provide a user interface (e.g., a webpage or other graphical user interface (“GUI”) displayed on a user device that has been networked through the internet with the sponsorship system, etc.) through which a contributor may select a contribution amount and designate a program or position, such as is available at Studentplayer.com (www.studentplayer.com), which website is fully incorporated herein by reference.

### Contributions

In an exemplary embodiment, persons or groups may contribute to and/or pledge contributions to an escrow fund as previously discussed. Contributions may be made and/or pledged through a user interface associated with the sponsorship program. The manner or manners in which contributions may be made and/or pledged may be defined by the sponsorship program, and may comprise any of a number of suitable techniques recognizable by a person skilled in the art. For example, a contribution may be made when a contributor provides directly to the sponsorship system (or to a third-party financial transaction system that has partnered with the crowdfunding system, e.g. Paypal or GoFundMe) with payment information and authorization to consummate a transaction.

In an exemplary embodiment, a fan's contribution will be credited to escrowed funds (which may be held for the desired institutional program or team participants either by the administrator of the system or at a financial institution). The user interface may be associated with a clearinghouse through which contributions from any number of sports fans or other contributors may be gathered, and from which any number of prospective athletic participants, endorsement sponsors, and potentially others (e.g., the media, coaching staff, university staff, the general public, etc.) may receive information in various embodiments about the cumulative value of the contributions, demographic and/or geographic information about the contributors, information that relates to the sponsorship commitments or similar information. Upon meeting the specific milestones, for example, being offered and accepting a position at the school and on the team, and completing an endorsement requirement, the team participant receives escrowed funds that have been contributed and/or pledged that are allocated to a team and/or his/her position.

### Maximum Team Strength Allocations

In some embodiments, if a contributor wishes to contribute to a team as a whole, rather than to individual positions, there are a plurality of manners in which the funds can be distributed. In one embodiment, for example, the contributor may elect to contribute: 1) equally to each team member, or 2) to a Maximize Team Strength (“MTS”) based on the system administrator's suggested allocations. Such MTS distributions may be specific to each sport and take into account the skill level of each individual position as well as the variance in the abilities of players who can fill that position. MTS allocations may also be set by others than the system administrator, for example, by a polling of preferences from the contributors.

In the absence of a contributor's specific instructions on how to allocate a donation to a school's team by position, the MTS allocation may default to an option specified by the system administrator. In each case, the percentage given represents the percentage of funds distributed to the team as a whole. For examples, the following MTS may be used:

Football

Quarterback (Starting): 21% Running Back (Starting): 7% Full Back (Starting): 3% Wide Receiver(s) (Starting): 6% Tight End(s) (Starting): 5% Left Tackle (Starting): 4% Right Tackle (Starting): 3% Center (Starting): 3% Left Guard (Starting): 3% Right Guard (Starting): 2% Defensive End (Starting): 3% Defensive Tackle (Starting): 3% Linebacker (Starting): 2% Cornerback(s) (Starting): 5% Strong Safety (Starting): 2% Free Safety (Starting): 3% Long Snapper (Starting): 2% Punter (Starting): 3% Place Kicker (Starting): 4% Remaining Team Members Combined: 16%.

Basketball

Point Guard (Starting): 14% Shooting Guard (Starting): 14% Strong Forward (Starting): 13% Power Forward (Starting): 13% Center (Starting): 16% Remaining Team Members Combined: 30%.

Other Sports

MTS allocations may be developed for other sports as well, e.g. baseball, softball, soccer, field hockey, swimming and diving, track and field, and other, and allocated in a methodology as determined by a system administrator or, for example, by contributor consensus, and so forth.

Escrowed Funds

Escrowing contributed funds prevents the particular team participant and/or team from being paid for their NIL rights until that team participant and/or team have provided the requisite endorsement or passed some other milestone as may be set by a system administrator. The system may monitor and detect actions periodically of whether the athletic participant has fulfilled his/her obligations to receive payment; and, if so, cause a disbursement from the escrowed funds to the particular athletic participant. The actions may include detecting from data available on the system database, or through third parties, whether the particular athlete is eligible; whether he/she has fulfilled their sponsorship obligation, and causing a disbursement to the particular athletic investment. The actions and/or endorsements that may be required of the athletic participant prior to disbursement of escrowed fund may be consistent with the regulations of the governing bodies of the sport in which the athletic participant participates and applicable law. The system may be configured to accept the team participant's self-reporting of completion of a sponsorship obligation, such as through a participant portal, or may retrieve such information from acknowledgement information provided through a sponsor for whom the endorsement was made, and/or a combination of verification through one or more means.

### Endorsement Obligations and Other Milestones

Various embodiments of endorsement obligations and other milestones for which an athletic participant may become eligible to receive contributions in escrow under the system disclosed include, but are not limited to, one or more of: signing a letter of intent with a particular school, attending a particular school, playing a particular position, remaining in school for a predetermined period of time or otherwise maintaining a player/position status for a predetermined period, meeting a personal performance goal, meeting a team performance goal, performing endorsement(s) or a sponsor, thanking the sports fans, sponsor or system administrator (e.g. StudentPlayer.com) who contributed to the towards supporting the institution or position or any of a number of other factors.

In a preferred embodiment, after qualifying for payment (e.g., by completing an endorsement) the athletic participant must complete a few brief posts/videos acknowledging the system administrator (e.g. StudentPlayer.com) and a few of his/her major sponsors. In such a preferred embodiment, it is expected that the athletic participant would need a brief amount of time (e.g. 5 minutes or less) to complete his/her obligation, and this endorsement may be provided through the team participant's cell phone, computer or tablet, such as submitting a video, Tweeting, Instagram, SnapChat, etc. The team participant will provide information for any forms required and abide by applicable law or rules. The system administrator may charge endorsement sponsors a fee in return for a team participant's endorsement. The system administrator may also receive revenue based on advertising on the host website other websites and/or other media, by using the database of contact information to broker endorsement deals for companies looking to sponsor a specific athlete, and from any interest income that accumulates on amounts held in escrow, amongst other auxiliary streams of income. The users of the system may be asked to enter various agreements provided by the system to memorialize the rights and relationships between the system administrator, team participants, contributors, sponsors and others (e.g., providing consents when registering online).

In other embodiments, a predetermined time period may be associated with achieving each milestone (e.g., the beginning of a season, the end of a regular season, the end of a particular playoff round, the end of the entire season, including playoffs, bowl games, Championship Tournament, etc.). An administrator of the sponsorship program may define the milestone actions required of a particular athletic participant, or in yet other embodiments of the invention, the conditional actions may be individually set by one or more contributors, for example a particular sponsorship endorsement. Alternatively, conditional actions may be defined on the basis of a consensus between a plurality of contributors.

In one embodiment, once one or more milestones for a particular athletic program or team participant by position have been established to receive an escrowed fund disbursement, those milestones may be made available to other sponsors who may have an interest in the particular program or athletic participant to whom the milestone actions correspond. In other embodiments, multiple potential sponsors may bid on priority to have access to the particular team participant.

### Information Provided Through the System

The information about such milestone actions to sports fans may be provided in one or more different ways, for example, on a graphical user interface, through an email, or a text issued by the system. For example, a contributor or prospective participant may receive a text about a new milestone action, an ongoing milestone for a particular athletic participant as the contributor accesses the interface of the sponsorship program to access a page reflecting the activity for a particular team or participant, or a special page that has been customized for use by the sports fan. In another embodiment, the sponsorship program may push automated messages (e.g., via e-mail, text messaging service, etc.) regarding milestones for particular team participants or contributions to sports programs to persons who have expressed a particular interest. In another embodiment, information of new and/or active milestone actions, contribution levels, team participant positions, disbursements and the like may be delivered to the media, which can make them available to a larger audience.

Users may receive updates that correspond to the conditional action may be provided. These updates may include information on the cumulative amount of funding that has been contributed and/or pledged toward a number of teams and/or athletic participants, demographic and/or geographic information about the contributions and news about activities, such as rumors and status updates on efforts to attract or recruit an athletic participant to a particular school or team, the team participants' school and/or team preferences, the team participants' progress towards an endorsement, or the like. Information about the contributions and/or sponsorship that have been made may be provided by the exemplary system. Other information may be collected by the system, alone or in conjunction with other systems, and then made available. Alternatively, a third party, such as a media outlet, may obtain information from the sponsorship system, and combine that information with current rumors and/or news about activities that pertain to a certain active conditional action, and then output that information together.

Without limitation, information may be sent or available to users and/or the system may also use such information in its marketing efforts or distribute such information to media outlets, which may encourage others to participate in the effort to influence the team participant (e.g., his or her decision on which school and/or team to join, etc.).

In some embodiments, the amount that has been contributed to an escrow account for a particular team participant may be reduced. Reductions may occur for certain types of penalties or for other egregious acts. If a reduction occurs, the reduced amount(s) may be refunded to the users from which the funds originated and/or redistributed to another part of team.

More details of one or more embodiments of the invention are set forth in the accompanying drawings and the detailed description below. Other features, objects, and advantages of the invention will be apparent from the description and drawings, and from the claims.

### BRIEF DESCRIPTION OF THE DRAWINGS

FIG. 1 is a schematic diagram of an embodiment of a sponsorship system according to this disclosure.

FIGS. 2A-2I are screen shot representations of an embodiment of the sponsorship system in which a contributor selects an athletic program and makes a contribution to one or more teams and/or athletic positions on a team.

FIG. 3 is a flow chart of and exemplary processes executed by a system according to this disclosure.

### DETAILED DESCRIPTION

An exemplary system of this disclosure promotes payments to programs and team participants in return for their completion of endorsements and other conditions.

In a preferred embodiment, a computerized system maintains sponsorship contributions to athletic programs for institutions, information about athletic participants fulfilling various roles for athletic teams, whether athletic participants have fulfilled milestones towards endorsements, payment from escrowed funds to the athletic participant as well as other information.

Although the exemplary embodiments will be generally described in the context of software modules running in a distributed computing environment, those skilled in the art will recognize that the present invention also can be implemented in conjunction with other program modules in a variety of other types of distributed or stand-alone computing environments. For example, in different distributed computing environments, program modules may be physically located in different local and remote memory storage devices. Execution of the program modules may occur locally in a stand-alone manner or remotely in a client/server manner. Examples of distributed computing environments include local area networks of an office, enterprise-wide computer networks, and the global Internet.

The detailed description that follows is represented largely in terms of processes and symbolic representations of operations in a computing environment by conventional computer components, which can include database servers, application servers, mail servers, routers, security devices, firewalls, clients, workstations, memory storage devices, display devices and input devices. Each of these conventional distributed computing components is accessible via a communications network, such as the internet, wide area network or local area network.

The invention comprises computer programs that embody the functions described herein and that are illustrated in the appended flow charts and schematics in referenced Figures. However, it should be apparent that there could be many different ways of implementing the invention in computer programming, and the invention should not be construed as limited to any one set of computer program instructions. Further, a skilled programmer would be able to write such a computer program to implement an exemplary embodiment based on the flow charts and associated description in the application text. Therefore, disclosure of a particular set of program code instructions is not considered necessary for an adequate understanding of how to make and use the invention. The inventive functionality of the claimed computer program will be explained in more detail in the following description read in conjunction with the figures illustrating the program flow.

Turning to the figures, in which like numerals indicate like elements throughout the figures, exemplary embodiments of the invention are described in detail.

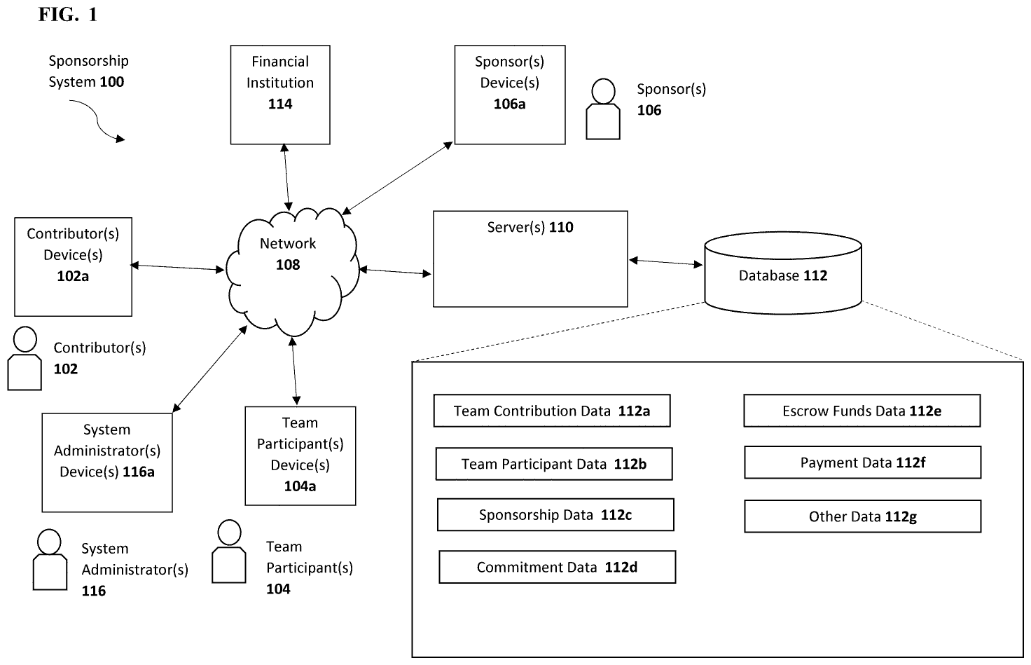

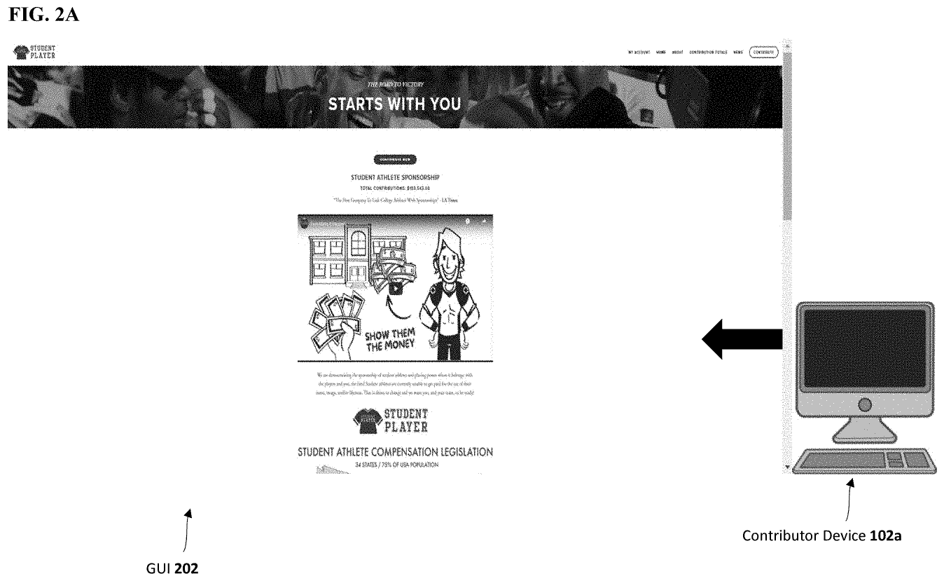

Referring to FIG. 1, and exemplary sponsorship system 100 for promoting payments to athletic programs and participants for NIL rights includes contributors 102 with contributor devices 102a, team participants 104 with team participant devices 104a, sponsors 106 with sponsors devices 106a, network 108, server(s) 110, and database 112. Contributor devices 102a are used by contributors 102, team participant devices 104a are used by team participants 104, and sponsor devices 106a are used by sponsors 106, to access server 110 via the network 108. User devices (including 102a, 104a, and 106a) can be any type of computing devices capable of taking input from a user over a network 108 with server 110, such as smart phones, personal digital assistants, tablets, laptops or personal computers and so forth.

A network 108 may include a memory, bus system, and processor. Server(s) 110 can be of a variety of computing devices capable of receiving data. Server may be a single server or a plurality of servers at one location or various location. The exemplary server 110 can receive data from user devices (including 102a, 104a, and 106a) via input/output (I/O) interface or other type of interface capable of receiving data over a network 108, including an Ethernet interface, wireless networking service, fiber-optic networking interface, modem and the like.

The computing devices 102a, 104a and 106a and server(s) 110 represented in FIG. 1 include one or more processing units, such as microprocessors manufactured by Intel Corporation of Santa Clara, Calif. or AMD (not shown). The computing devices also include system memory, including read only memory (ROM) and random-access memory (RAM), which are connected to the processing units. Those skilled in the art will also appreciate that the present invention may be implemented on computers having other architectures, operating systems, and those that utilize other microprocessors. Users may enter commands and information into the computing devices by using input devices, such as keyboards and/or pointing devices, such as a mouse. One or more monitors or other kind of display devices is connected to the computing devices. Although other internal components of the computing devices and servers are not shown in the Figures, those of ordinary skill in the art will appreciate that such components and the interconnection between them are well known. Accordingly, additional details concerning the internal construction of the computing devices need not be disclosed in connection with the present invention. Those of skill in the art will recognize that exemplary method and the following discussion are merely one embodiment of the invention. In alternate embodiments of the invention, certain steps of the method may be performed in a different sequence, performed in parallel, or eliminated altogether. Furthermore, in alternate embodiments of the invention other software modules operating on local or remote computing devices may perform the steps of exemplary method.

Thus, the network 108 may be used to enable the communication of information from the one or more servers 110 to the user devices 102a, 104a and 106a. Such communication may occur in any of a variety of formats that enable computer processors of the user devices 102a, 104a and 106a, while executing computer programs, such as web browsers or specialized software applications (e.g., “apps” running on smart phones, media players, tablet computers, etc.), to output, or convey, the information to end users. Without limitation, the system 100 may provide information such as text, still images, audio, video, multi-media (e.g., any combination of the foregoing) and/or other formats.

In an exemplary embodiment, the server 110 may automatically kickoff a workflow to actively and automatically perform certain actions. In an exemplary embodiment, server 110 obtains from users, and stores to records in the database 112a-f, various information, including, without limitation, team contribution data 112a, team participant data 112b, sponsorship data 112c, commitment data 112d, escrowed funds data 112e, payment data 112g and other data 112g. The server 110 for example, may be part of a web server, such as an Internet Information Services (IIS) for Windows® server for hosting on the internet.

The various records in the database 112a-f includes information used by the system 100 to allocate escrowed funds to team participants 104. For example, team contribution data 112a includes the name of the institution, team and the allocation by position which the server 110 uses to compute a monetary disbursement to a team participant 104 upon meeting certain milestones.

In one embodiment, a user may enter information on a user device (e.g 102a, 104a, 106a) that populates information from the server 110 to the database 112 for various data 112a-g. In another example, the server may obtain one or more types of information 112a-g by accessing team contribution data 112a or sponsorship data 112c stored in the database 112. The server 110 also may obtain one or more types of information for milestones reached by each team participant 112b. One or more types of information 112a-g are used by the server 110 to allocate funds to team participants 104. A system administrator 116 may interact with the system and populate information to the database through a system administrator device 116a.

In an exemplary embodiment, the team contribution data 112a may contain information about a plurality of schools. The team participant data 112b may include information may include the personal information about the team participant 104, including, but not limited to, his or her name, sport(s), position(s), age, hometown, playing history (e.g., high school(s), college(s), etc.), current team, a short biography, statistics, current class (e.g., high school grade, freshman, sophomore, junior, senior, redshirt status, etc.) and/or any combination of the foregoing.

In the exemplary embodiment in FIG. 1, the system 100 also includes a financial institution 114 in which disburses funds that have been escrowed and due to the athletic participant 104. In one embodiment, the server 110 executes one or more rules and/or trigger events that use one or more types of information 112a-g from the database 112, to direct funds held in escrow to be paid a team athletic participant 104, upon that team participants completion of a commitment or milestone. The server 110 may detect from a check on the milestone information from information stored in the database 112a-g of whether the milestone has been reached for the team participant 104. Then the server 110 causes a transfer of funds escrowed for a team or team participant 104 to the athletic participant 104 in an amount specified by in the payment data 112f. If endorsements are not completed properly, or other information is required, the server 110 may cause information to be sent to the team participant 104 and/or sponsor 106 through their respective devices (104a, 106a) to correct errors. Once the athletic participant 104 has fulfilled the endorsement commitment, the server 110 updates the information on the database 112, prior to disbursement of funds. In an exemplary embodiment, if the endorsements are completed satisfactorily, after payment is issued, all reporting required by law (either to the IRS, college, or other governmental agency) is completed by the system administrator 116 and/or through the system 100.

In an exemplary embodiment, each year a team participant 104 participates in on a team, server 110 generates an individual record for each team participant 104, including the team participant name, eligibility year, position, sponsors 106, and milestone or endorsement commitments. Server 110 tracks and accumulates these records over time to reflect an accurate amount of escrowed funds allocated and disbursed. Server 110 may aggregate the individual records to calculate an aggregate balance or amount of escrowed funds owed to a team participant 104. Additionally, server 110 may track records for multiple team participants (e.g., on a yearly, basis) and for multiple schools. Server 110 aggregates the records for team participants at a particular school, e.g., to determine an aggregate balance in the funds that are held by team participants of the particular school.

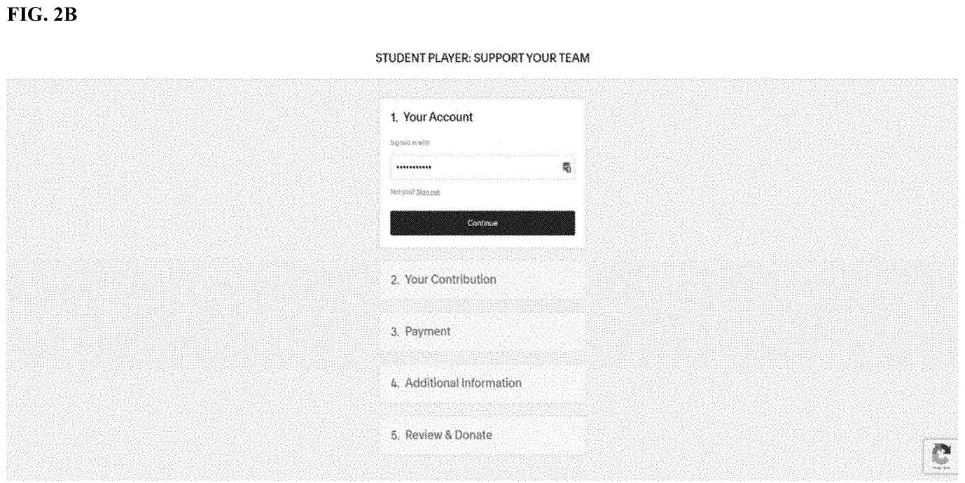

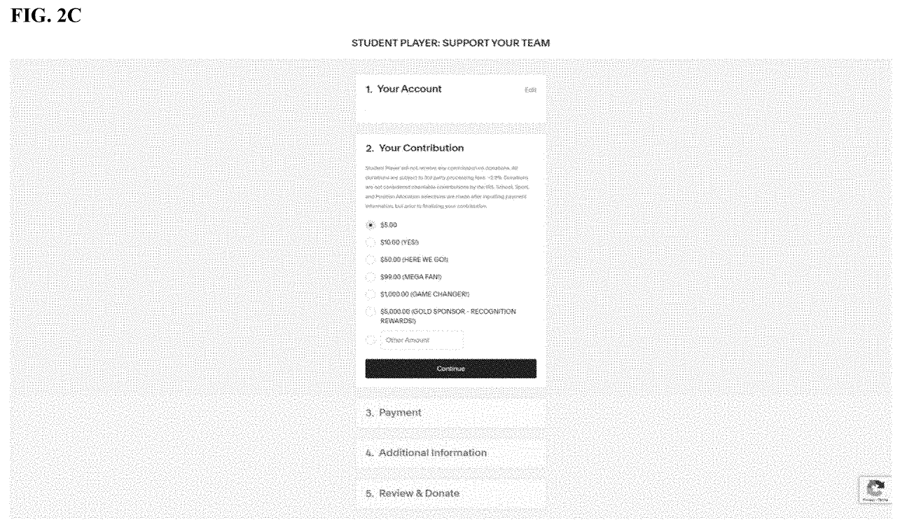

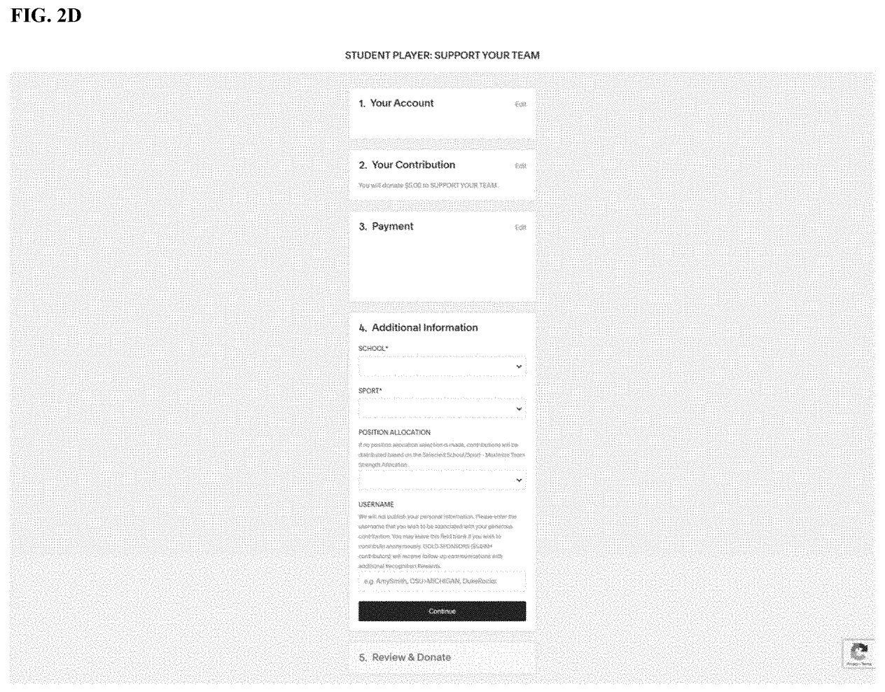

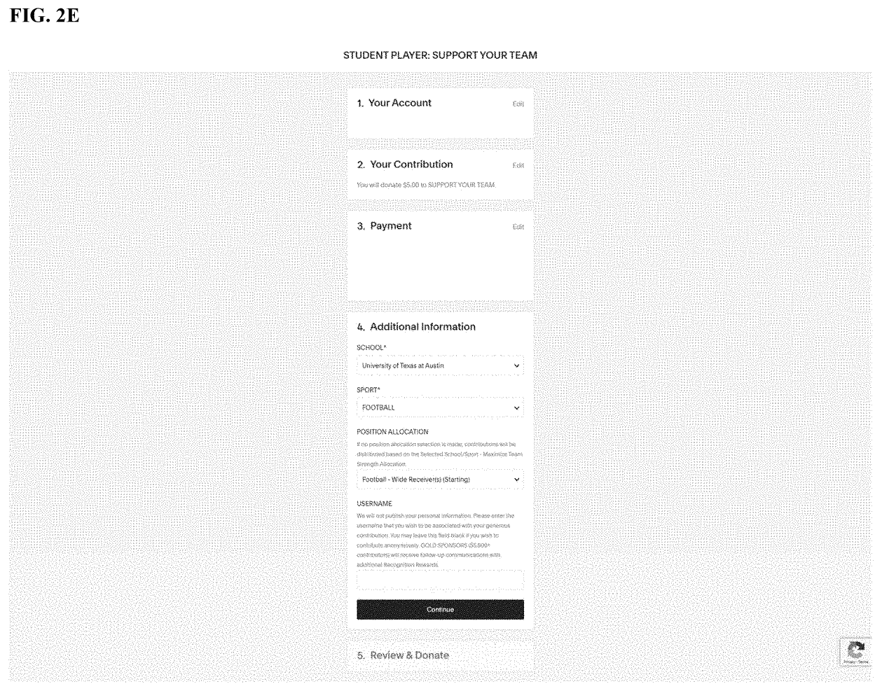

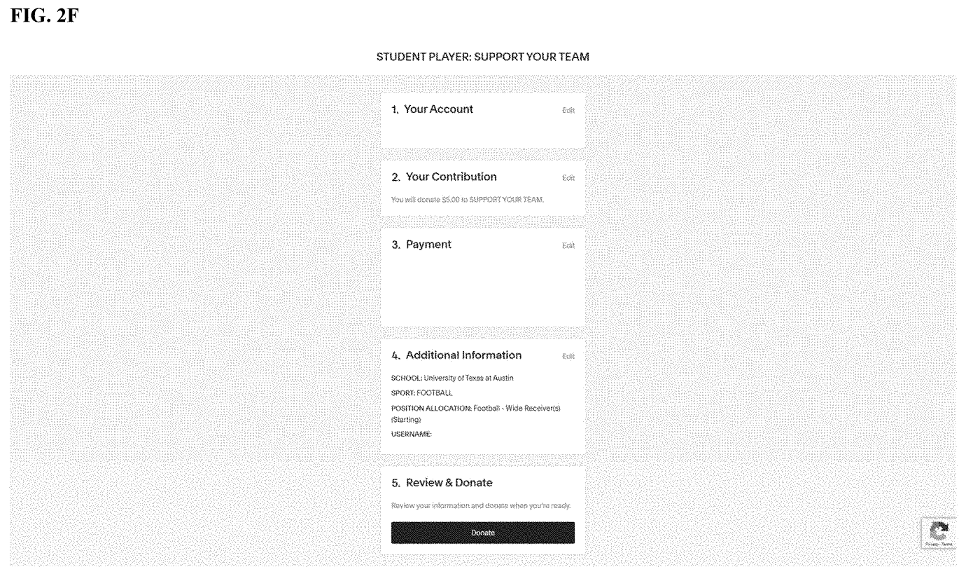

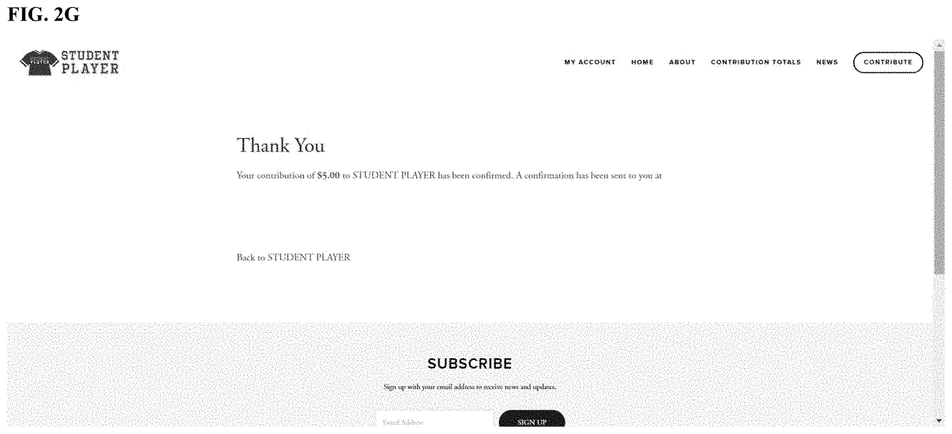

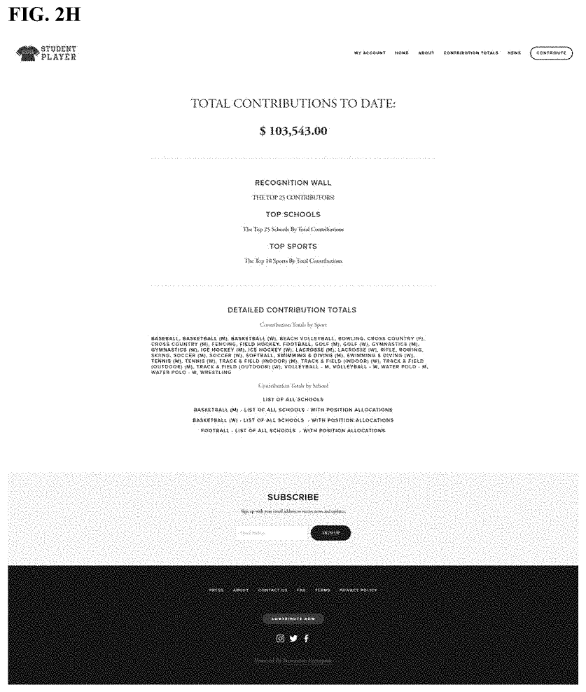

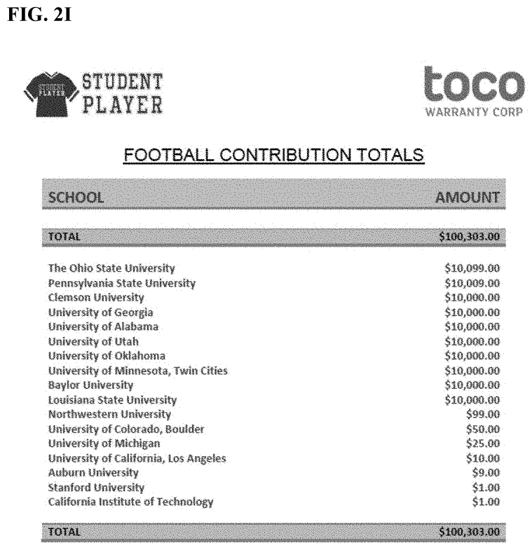

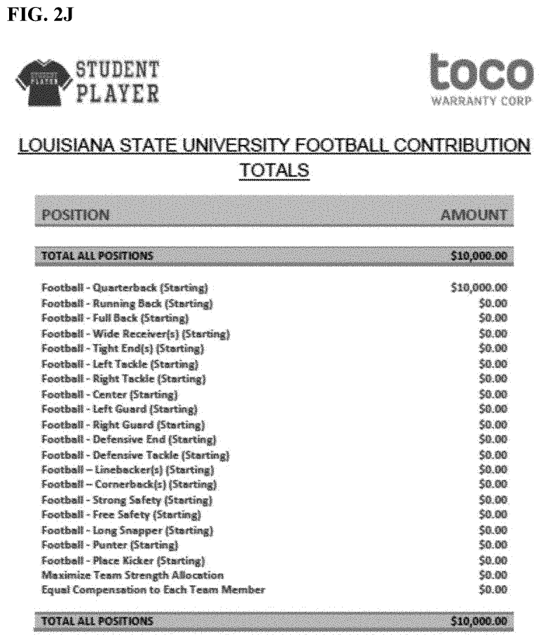

In an exemplary embodiment in FIGS. 2A-J, the server 110 generates one or more GUIs 202 such as shown for example in FIG. 2A and various users, including existing and prospective contributors 102, team participants 104, sponsors 106 and the public. The foregoing may view the graphical user interfaces, make contributions, sponsorships, and view escrowed amounts allocated to a particular team and/or a particular position, and other interactions with the system over the user devices 102a, 104a and 106a.

For example, to “contribute” to a particular team, a contributor 102 views the GUI 202 over his/her contributor device 102a, and selects the “Contribute” button or hyperlink. The server 110 then generates the GUI as illustrated in FIG. 2B. A first exemplary inquiry requests account information including a user name (email) and password. If the contributor has not previously registered, he/she is asked to register at this time. Once the contributor 102 selects the “continue” button he/she is taken to the next GUI screen where he/she is prompted to select a contribution amount from a menu or to input an amount as shown in FIG. 2C. Once a contribution amount is selected, the contributor 102 selects “continue” the server 100 generates the next GUI screen where payment information (e.g. credit card, PayPal) is entered, as illustrated in FIG. 2D. Once payment information is entered and the contributor 102 selects “continue” the server 100 generates the next GUI screen where “additional information” (e.g. school, sport and position allocation) is entered, as illustrated in FIG. 2E. The contributor 102 is prompted to select a “school”, “sport” and “position allocation” from drop-down menus and select a username as shown in FIG. 2E. After the contributor 102 selects “continue” again the server 100 generates the next GUI screen where the contributor 102 is requested to review and donate the order by selecting the “donate” button, as illustrated in FIG. 2F. Once the “donate” button is selected the server 100 confirms the contribution and adds populates the database information 112a-f appropriately. A receipt is generated and provided by the server 110 on the screen to the contributor 102 on contributor's device 102a as shown in FIG. 2G, and other confirmation, such as an email or text may be sent to the contributor 102 as well.

Turning to FIG. 2H, the server 110 may generates one or more GUI's to allow the user to view various information on contributions made, including, for example recognizing top contributors 102, top schools and top sports for contributions. The user may also explore detailed contribution totals by sport or by school, as shown as an example in FIG. 2H. In this example, the user may select one or more hyperlinks that would take him/her to, for example the Football Contribution Totals as shown in FIG. 2I, or to totals by position of a school as shown in FIG. 2J.

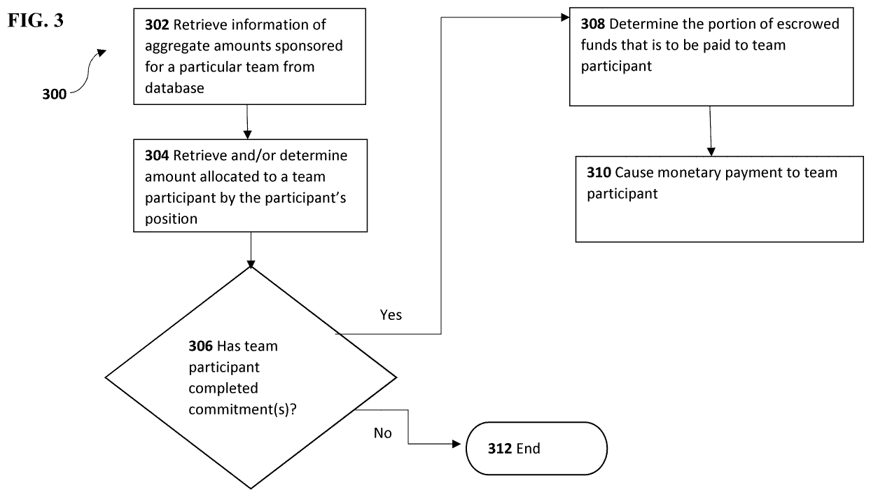

Referring to FIG. 3, in an exemplary implementation as discussed above, a server 110 implements process 300 in retrieving 302 information of aggregate amounts sponsored for a particular sports team from the database 112 (e.g. as represented by team contribution data 112a). Server 110 also retrieves and/or determines 304 the amount to be allocated to a team participant by the participant's position (e.g. as represented by team participant data 112b). Server then detects 306 whether a particular team participant has completed one or more specific commitments (e.g. as represented by one or more of sponsorship data 112c and/or commitment data 112d). The server then determines 308, based upon whether the team participant 104 has completed his/her commitment (e.g. as represented by commitment data 112d), the escrowed amount (e.g. as represented by escrow funds data 112e) that is to be paid by the particular team participant 104. If the required commitment is not completed, the process 300 ends 312. The server 110 then causes a monetary disbursement 310 from an escrow account to the particular team participant 104 (e.g. to an account set up by team participant 104 or as recorded in his/her device 104a) in the amount determined to be paid and then updates the escrow fund data 112e and payment data 112f.

In one embodiment, server 110 may cause the disbursement by sending notifications and/or instructions to the financial institution 114 to cause a disbursement for a specified amount to a team participant 104.

In some embodiments, server 110 may determine Maximize Team Strength (“MTS”) allocation to a particular team participant 104 if this option has been selected for certain escrowed fund.

In some examples, several financial options may allow for early disbursement prior to completing the milestone, upon a specific need or the team participant 104 signing a promissory note or other commitment with the system administrator 116.

A number of embodiments of the invention have been described. Nevertheless, it will be understood that various modifications and variations may be made without departing from the spirit and scope of the invention.

The figures and descriptions of the present invention have been simplified to illustrate elements that are relevant for a clear understanding of the present invention, e eliminating, for the purposes of clarity, many other elements found in typical computing apparatuses, systems and methods. Those of ordinary skill in the art will recognize that other elements are desirable and/or required in order to implement the present invention. However, because such elements are well known in the art, and because they do not facilitate a better understanding of the present invention, a discussion of such elements is not provided herein.

What is claimed is:

1. A computer-implemented method comprising:
retrieving information of aggregate amounts sponsored for a particular team from a plurality of teams;
determining the amount allocated to a team participant by the participant's position for a particular team;
detecting that a particular team participant has completed one or more specified commitments;
determining, based upon whether the team participant has completed said specified commitments, the portion of the aggregate amount sponsored for a particular sports team that is paid to the particular team participant based on the participant's position; and
causing a monetary disbursement to the particular team participant.

2. An electronic system comprising one or more processing devices and one or more machine-readable hardware storage devices storing instructions that are executable by the one or more processing devices configured to perform operations comprising:
retrieving information of aggregate amounts sponsored for a particular team from a plurality of teams;
determining the amount allocated to a team participant by the participant's position for a particular team;
detecting that a particular team participant has completed one or more specified commitments;
determining, based upon whether the team participant has completed said specified commitments, the portion of the aggregate amount sponsored for a particular sports team that is paid to the particular team participant based on the participant's position; and
causing a monetary disbursement to the particular team participant.

3. One or more machine-readable hardware storage devices storing instructions that are executable by one or more processing devices to perform operations comprising:
retrieving information of aggregate amounts sponsored for a particular team from a plurality of teams;
determining the amount allocated to a team participant by the participant's position for a particular team;
detecting that a particular team participant has completed one or more specified commitments;
determining, based upon whether the team participant has completed said specified commitments, the portion of the aggregate amount sponsored for a particular sports team that is paid to the particular team participant based on the participant's position; and
causing a monetary disbursement to the particular team participant.
